(19) United States
(12) Patent Application Publication
(10) Pub. No.: US 2009/0050104 A1
(43) Pub. Date: Feb. 26, 2009

(54) VALVE GUIDE FOR INTERNAL COMBUSTION ENGINE HAVING MEANS FOR MIXING FUEL

(76) Inventor: Young-Pyo Hong, Seoul (KR)

Correspondence Address: IPLA P.A., 3580 WILSHIRE BLVD., 17TH FLOOR, LOS ANGELES, CA, 90010, US

(21) Appl. No.: 11/573,543

(22) PCT Filed: Jul. 5, 2005
(86) PCT No.: PCT/KR05/02126

§ 371 Date: Feb. 9, 2007

(30) Foreign Application Priority Data
Aug. 16, 2004 (KR) 10-2004-0064412

(51) Int. Cl. F02B 31/00

(52) U.S. Cl. 123/306; 123/188.9

(57) ABSTRACT

The present invention relates to a valve guide for an internal combustion engine, and more particularly, to a swirling valve guide having a fuel mixing means installed on an outer peripheral surface of the valve guide, which protrudes into an intake port of an internal combustion engine, to promote mixing of fuel and air. According to the present invention, there is provided a swirling valve guide including a guide portion installed to protrude into an intake port of a cylinder head of an internal combustion engine for guiding reciprocation of an intake valve of the internal combustion engine, comprising a fuel mixing mean having a member installed on an outer peripheral surface of the guide portion to mix fuel and air passing the intake port and to produce a swirl in a mixture of the fuel and air at a downstream side of the flow of the mixture. With the present invention, the fuel mixing means is installed on the valve guide adjacent to a combustion chamber to produce a swirl so that a mixture of fuel and air can be introduced into the combustion chamber in a state where the fuel and air are appropriately mixed with each other, hi addition, the fuel mixing means is installed on a conventional valve guide to minimize a disturbance of the flow of the mixture.

### TECHNICAL FIELD

The present invention relates to a valve guide for an internal combustion engine, and more particularly, to a swirling valve guide having a fuel mixing means installed on an outer peripheral surface of the valve guide, which protrudes into an intake port of an internal combustion engine, to promote mixing of fuel and air.

### BACKGROUND ART

FIG. 1 is a sectional view showing a state where a conventional valve guide is installed in a cylinder head of an internal combustion engine.

An intake port 11, which is a flow passage for a mixture of fuel and air, is formed in a cylinder head 10. An inlet of the intake port 11 is connected to an intake manifold 12, while an outlet of the intake port is connected to a combustion chamber 13. The mixture of fuel and air is supplied from the intake manifold 12 to the combustion chamber 13 via the intake port 11, and the flow of the mixture is intermittently controlled at an inlet of the combustion chamber 13 by an intake valve 14. The intake valve 14 is connected to a valve stem 15 and reciprocates in a direction designated by an arrow in the figure. A valve guide 100 is required to guide the reciprocation. The valve guide 100 is formed in a hollow cylinder and guides an up and down motion of the valve stem 15 inserted in the hollow of the valve guide. Simultaneously, the valve guide 100 serves to transfer heat from the intake valve 14 to the cylinder head and thus cool the intake valve. To this end, the valve guide 100 comprises a fixed portion 101 fixed to the cylinder head 10, and a guide portion 102 protruding into the intake port 11.

It is well known that better uniformity of the mixture of fuel and air supplied to the combustion chamber of the internal combustion engine advantageously reduces incomplete combustion and knocking and also increases power. To this end, there have been developed a variety of swirling units each of which is inserted into either the intake manifold or between the intake manifold and an air cleaner so as to induce a swirl of either the mixture of fuel and air or air. Such conventional swirling units include fixed blades installed in the hollow of a housing in the form of a hollow cylinder, or rotary blades installed in a housing so that they can rotate about a central axis in a longitudinal direction of the housing. In addition, there is an example in which vanes 3 are installed on an intake port-facing surface of an intake valve 2 to form a swirl, as shown in FIG. 2.

Since the conventional swirling unit is installed in the intake manifold or between the intake manifold and the air cleaner, however, the swirl is considerably weakened due to friction in a pipe before air that has passed the swirling unit reaches a fuel injector or the combustion chamber. In addition, since the conventional swirling unit produces a swirl of only air rather than a direct swirl of the mixture of fuel and air, it is difficult to achieve the objective of uniform mixing of the fuel and air. Further, since a rotary body for forming a swirl is installed in the hollow of the housing, there is a problem in that the rotary body disturbs the flow of air.

In the meantime, the conventional swirling unit in which the vanes are installed on the intake port-facing surface of the intake valve is intended to directly produce a swirl of the mixture of fuel and air. However, the swirling unit sometimes moves in the same direction as the flow of the mixture while the swirling unit reciprocates together with the intake valve. At this time, there is a problem in that a sufficient swirl of the mixture is not formed. In addition, the vanes formed on the surface of the intake valve is likely to be damaged due to frequent reciprocation of the intake valve and heat transferred from the combustion chamber. If any of the vanes is broken due to impact caused by the reciprocation of the intake valve, the overall operation of the internal combustion engine is fatally affected.

### DISCLOSURE

### Technical Problem

An object of the present invention is to provide a swirling valve guide capable of promoting mixing of a mixture of fuel and air by forming a swirl. Another object of the present invention is to provide a swirling valve guide for forming a swirl while minimizing a disturbance of the flow of the mixture by installing a fuel mixing means on a conventional valve guide that protrudes into an intake port. A further object of the present invention is to provide a swirling valve guide capable of forming a swirl of the mixture regardless of impact caused by reciprocation of a valve.

### Technical Solution

According to an aspect of the present invention for achieving the objects, there is provided a swirling valve guide including a guide portion installed to protrude into an intake port of a cylinder head of an internal combustion engine for guiding reciprocation of an intake valve of the internal combustion engine, comprising a fuel mixing mean having a member installed on an outer peripheral surface of the guide portion to mix fuel and air passing the intake port and to produce a swirl in a mixture of the fuel and air at a downstream side of the flow of the mixture. Preferably, the member for forming the swirl comprises at least one blade fixed on the outer peripheral surface of the guide portion. Particularly, it is preferred that the fuel mixing means further comprise a hub rotatably installed on the outer peripheral surface of the guide portion, and the at least one blade be fixed to an outer peripheral surface of the hub.

In the swirling valve guide of the present invention, a plurality of blades may be provided and the valve guide may further comprise a reinforcing rim with an inner peripheral surface connected to ends of the plurality of blades.

The swirling valve guide of the present invention preferably further comprises an auxiliary blade fixed to at least one of outer and inner peripheral surfaces of the reinforcing rim.

In the swirling valve guide of the present invention, a plurality of blades may be provided, and the blades may be arranged equidistantly in a circumferential direction on the outer peripheral surface of the guide portion.

In the swirling valve guide of the present invention, the at least one blade preferably has a spiral shape that is inclined at a predetermined angle with respect to a longitudinal direction of the valve guide.

In the swirling valve guide of the present invention, the at least one blade is preferably formed with an extension at an end thereof such that the extension extends toward an upstream side of the intake port.

In the swirling valve guide of the present invention, a plurality of fuel mixing means may be provided, and the blade of one of the fuel mixing means may have a spiral shape inclined at a predetermined angle with respect to a longitudinal direction of the valve guide and have an inclination angle different from that of the blade of the adjacent fuel mixing means.

### DESCRIPTION OF DRAWINGS

FIG. 1 is a sectional view showing a state where a conventional valve guide is installed in a cylinder head.

FIG. 2 is a perspective view of vanes installed on an intake port-facing surface of a conventional valve.

FIG. 3 is a perspective view of a first embodiment of the swirling valve guide according to the present invention.

FIG. 4 is a perspective view of a second embodiment of the swirling valve guide according to the present invention.

FIG. 5 is a perspective view of a third embodiment of the swirling valve guide according to the present invention.

FIG. 6 is a sectional view of a state where the embodiment of FIG. 5 is installed in a cylinder head.

FIG. 7 is a perspective view of a fourth embodiment of the swirling valve guide according to the present invention.

FIG. 8 is an exploded perspective view of a fifth embodiment of the swirling valve guide according to the present invention.

FIG. 9 is an exploded perspective view of a sixth embodiment of the swirling valve guide according to the present invention.

FIG. 10 is a perspective view showing an assembled state of the embodiment of FIG. 9.

FIG. 11 is a sectional view showing a state where the embodiment of FIG. 9 is installed in a cylinder head.

FIG. 12 is a sectional view showing a state where a seventh embodiment of the swirling valve guide according to the present invention is installed in a cylinder head.

FIG. 13 is a sectional view showing a state where an eighth embodiment of the swirling valve guide according to the present invention is installed in a cylinder head.

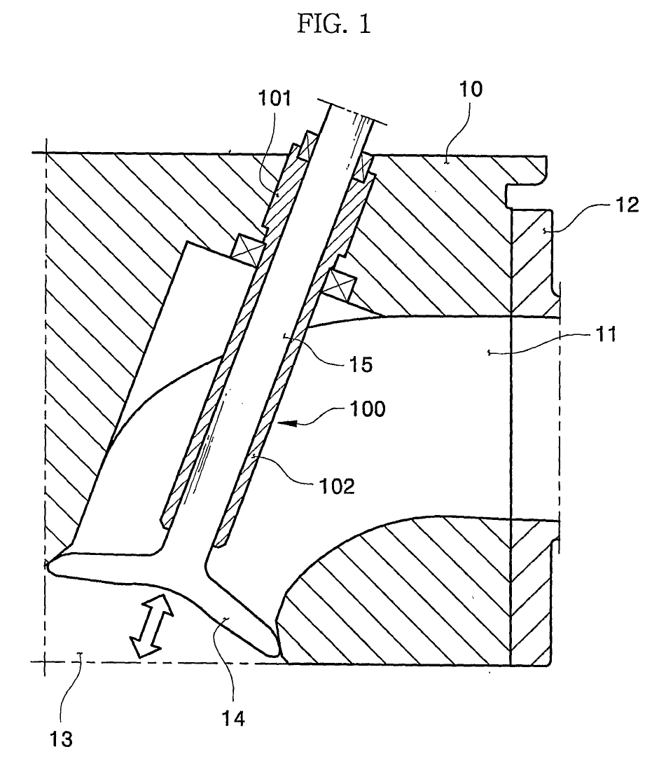

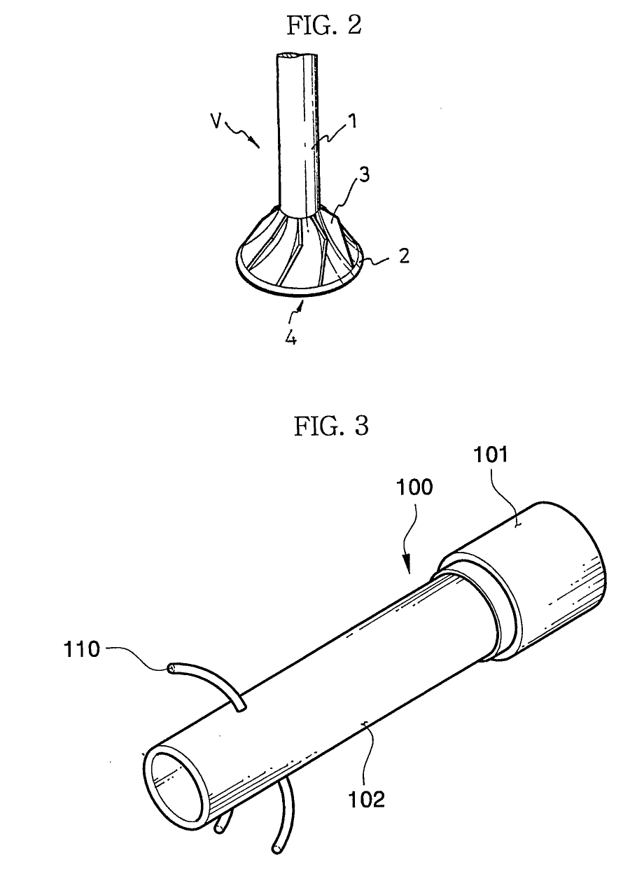

### EXPLANATION OF REFERENCE NUMERALS TO MAIN PORTIONS OF DRAWINGS

100: Valve guide
200, 300, 400, 500: Fuel mixing means

### Best Mode

Hereinafter, preferred embodiments of the present invention will be described in detail with reference to the accompanying drawings.

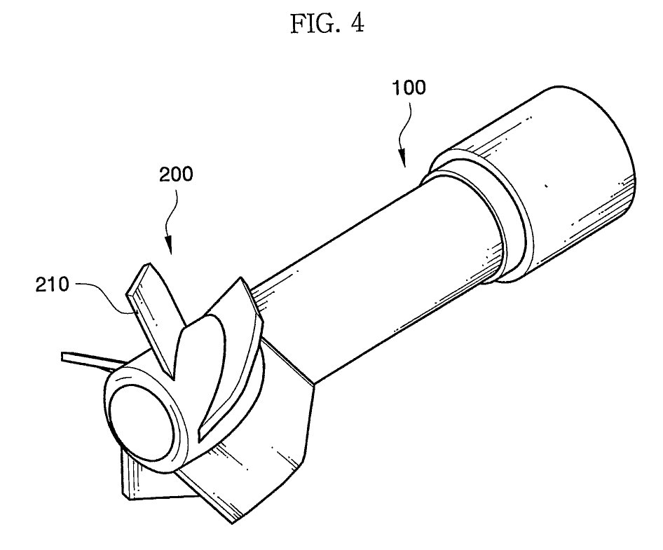

FIG. 3 is a perspective view of a first embodiment of a swirling valve guide according to the present invention.

The valve guide generally comprises a base portion 101 that takes the shape of a hollow cylinder and is to be inserted into a cylinder head, and a guide portion 102 protruding into an intake port to guide reciprocating motion of a valve. A fuel mixing means is installed on an outer peripheral surface of the guide portion 102 of the valve guide 100. The fuel mixing means includes members 110 for mixing fuel with air. Since the members 110 may be any members so far as they produce a swirl of a mixture of fuel and air at a downstream side of the flow of the mixture, the members 110 may be protruding rods 110 as shown in the figure. Particularly, if the rods 110 are elastic members bent toward the downstream side of the flow of the mixture, the rods are swayed due to the flow of the mixture and accordingly produce a swirl in the flow of the mixture, thereby promoting the mixing of the fuel and air.

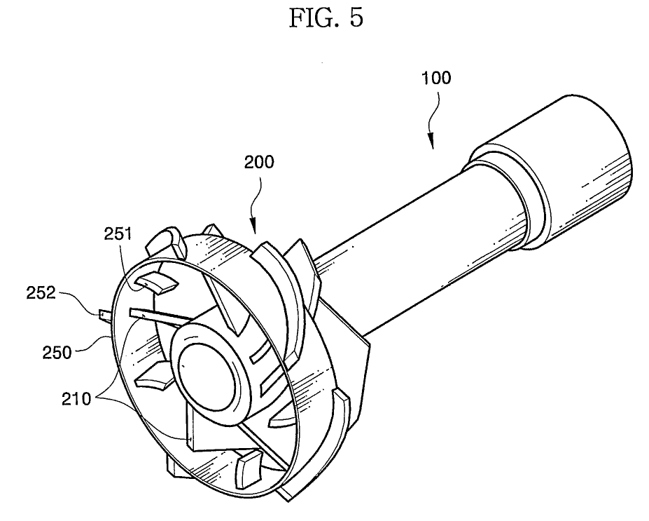

FIG. 4 is a perspective view of a second embodiment of the swirling valve guide according to the present invention.

A fuel mixing means 200 of this embodiment includes a protruding blade 210 as a member for mixing fuel with air. It is preferred that a plurality of blades 210 be provided and each of the blades 210 have a spiral shape inclined at a predetermined angle with respect to a longitudinal direction of the valve guide.

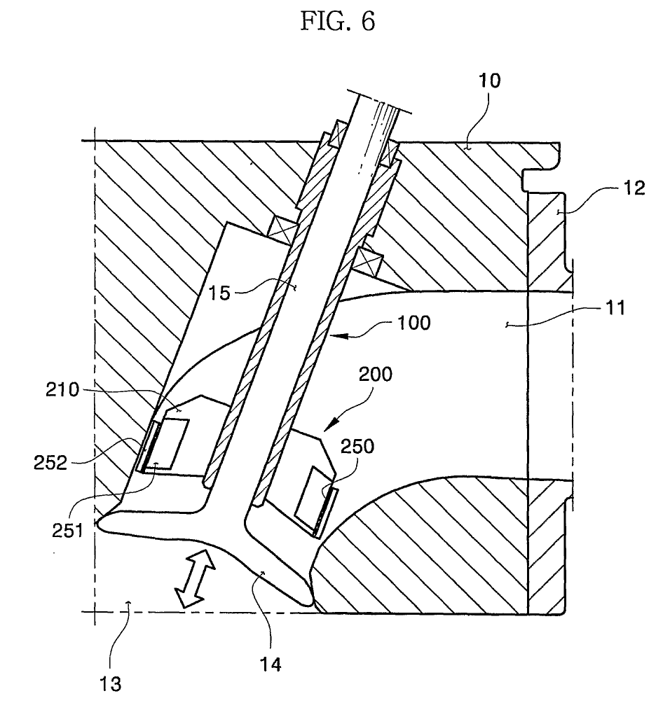

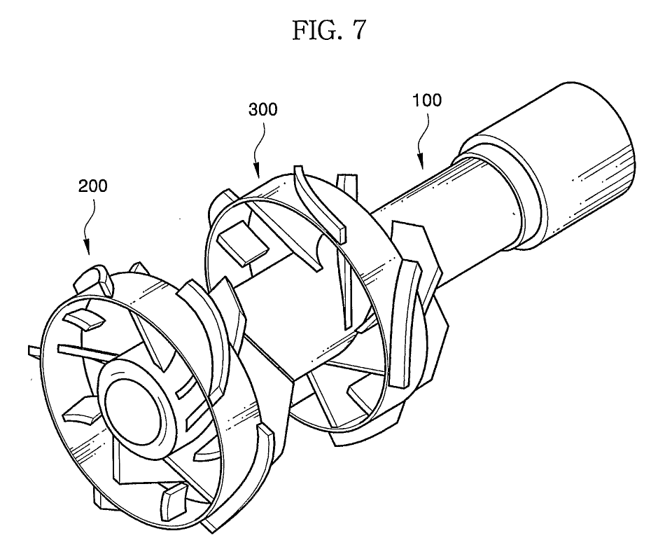

FIG. 5 is a perspective view of a third embodiment of the swirling valve guide according to the present invention, and FIG. 6 is a sectional view showing a state where the embodiment of FIG. 5 is installed in a cylinder head.

A fuel mixing means 200 of this embodiment further comprises a reinforcing rim 250 of which an inner peripheral surface is connected to ends of the plurality of blades 210, as compared with the previous second embodiment. The reinforcing rim 250 reinforces the blades 210 and increases the strength thereof by supporting the ends of the blades 210. Further, it is preferred that auxiliary blades 251 and 252 be fixed to the reinforcing rim 250. The auxiliary blades 251 and 252 may be arranged on either one of inner and outer peripheral surfaces of the reinforcing rim 250 or both of them. When the present embodiment is installed in a cylinder head 10 as shown in FIG. 6, a valve stem 15 is inserted into the hollow of the valve guide 100 and reciprocates in a direction designated by an arrow, and an intake valve 14 intermittently controls the mixture of fuel and air supplied to a combustion chamber 13. At this time, when the mixture of fuel and air that has passed an intake manifold 12 collides against the fuel mixing means 200 installed on the valve guide 100 while passing through an intake port 11, the direction of the flow of the mixture is changed according to the shapes of the blades 210. This produces a swirl of the mixture, thereby promoting the mixing of the fuel and air. In this process, the reinforcing rim 250 and the auxiliary blades 251 and 252 considerably promote the formation of the swirl.

FIG. 7 is a perspective view of a fourth embodiment of the swirling valve guide according to the present invention.

This embodiment includes a plurality of fuel mixing means each of which is similar to that of the previous third embodiment. That is, a first fuel mixing means 200 and a second fuel mixing means 300 are arranged in a line in the longitudinal direction of the valve guide 100. Although each fuel mixing means has the same configuration as the third embodiment in this figure, the configurations of the fuel mixing means of the first and second embodiments may be selected. In addition, if the inclination angle of each of the blades of the first fuel mixing means 200 with respect to the longitudinal direction of the valve guide is different from that of each of the blades of the second fuel mixing means 300, it is possible to produce a stronger swirl of the mixture that has passed the respective fuel mixing means.

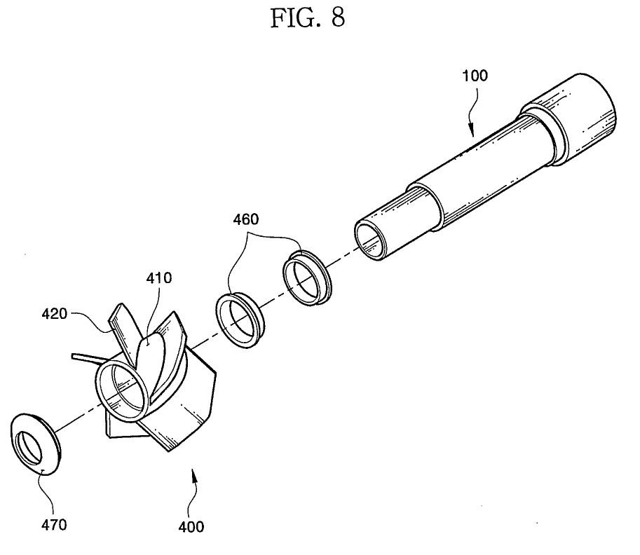

FIG. 8 is an exploded perspective view of a fifth embodiment of the swirling valve guide according to the present invention.

Contrary to the previous embodiments, this embodiment is characterized in that a fuel mixing means 400 further comprises a hub 410. The hub 410 is coupled to the outer peripheral surface of the valve guide 100, and blades 420 are fixed to an outer peripheral surface of the hub. It is preferred that the hub 410 be rotatably installed to the valve guide 100 using a proper number of general bearings 460. In the case where the hub 410 is rotatably installed, when a mixture of fuel and air passes the fuel mixing means 400, resistance against the flow of the mixture is considerably reduced as compared with a case where the hub 410 is fixed. Thus, the intake efficiency of an internal combustion engine is not greatly lowered. In this case, to prevent the fuel mixing means 400 from coming off from the valve guide 100, it is necessary to fix a stopper 470 to a distal end of the valve guide 100. The stopper 470 tales the shape of a ring with a through-hole through which a valve stem passes.

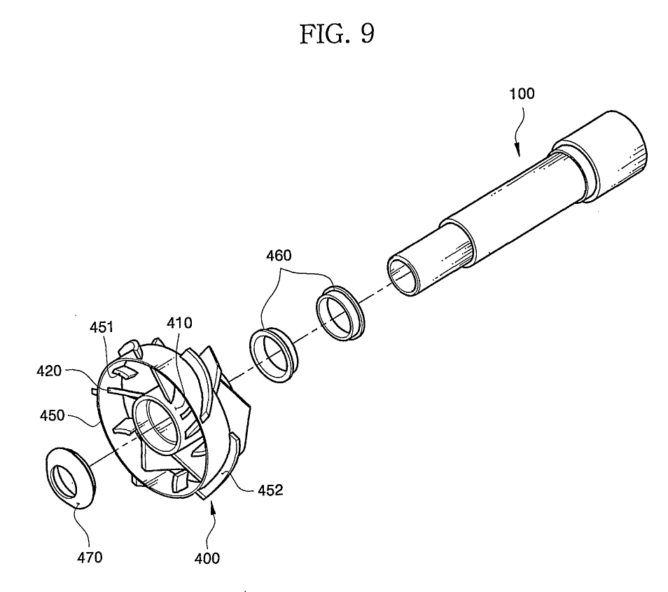

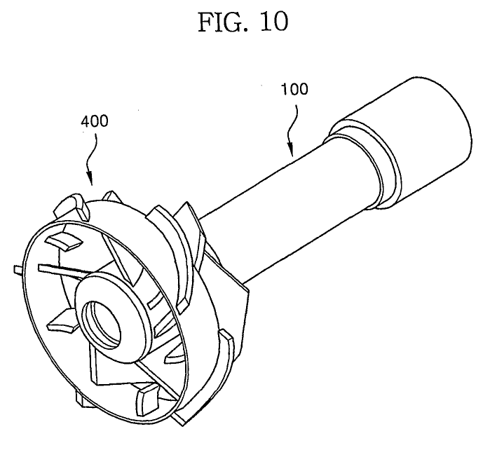

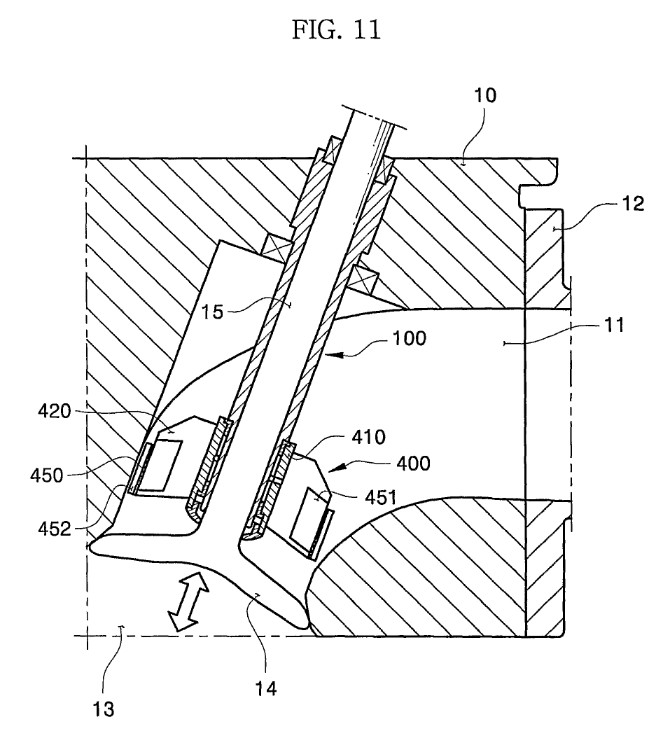

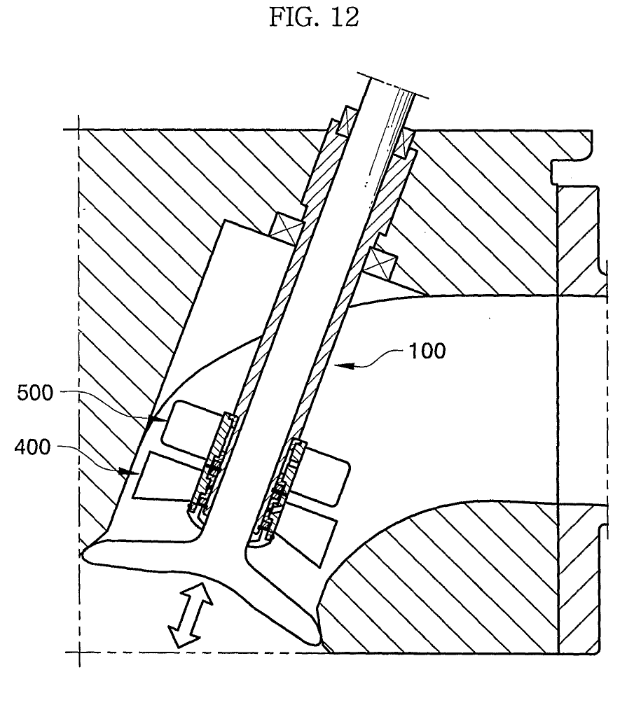

FIG. 9 is an exploded perspective view of a sixth embodiment of the swirling valve guide according to the present invention, FIG. 10 is a perspective view showing an assembled state of the embodiment of FIG. 9, and FIG. 11 is a sectional view showing a state where the embodiment of FIG. 9 is installed in a cylinder head.

This embodiment is different from the previous fifth embodiment in view of the configuration of the fuel mixing means 400. Likewise the previous third embodiment, the fuel mixing means 400 of this embodiment further comprises a reinforcing rim 450 and auxiliary blades 451 and 452 fixed to the reinforcing rim. Particularly, when the hub 410 is rotatably installed to the valve guide 100 through the bearings 460, the necessity of the reinforcing rim 450 is more increased. That is, when the mixture supplied from the intake manifold 12 to the intake port 11 passes the fuel mixing means 400 and collides against the blades 420, thereby rotating the fuel mixing means 400. As a rotational speed is increased, the amount of the mixture that radially escapes along the surfaces of the blades 420 is increased. Since the escaping mixture disturbs the flow of remaining mixture, it may be a cause of deterioration of the intake efficiency. The reinforcing rim 450 serves not only to structurally reinforce the blades 420 but also to suppress the escape of the mixture. The auxiliary blades 451 and 452 may be fixed to either one of the inner and outer peripheral surfaces of the reinforcing rim 450 or both of them to produce a stronger swirl of the mixture passing the fuel mixing means 400.

FIG. 12 is a sectional view showing a state where a seventh embodiment of the swirling valve guide according to the present invention is installed in a cylinder head.

This embodiment is different from the previous embodiments in that this embodiment comprises a plurality of fuel mixing means. For example, a first fuel mixing means 400 and a second fuel mixing means 500 are arranged in a line along the longitudinal direction of the valve guide 100. Each of the fuel mixing means 400 and 500 may selectively employ the configuration of the fuel mixing means of the fifth or sixth embodiment. Thus, each of the fuel mixing means may be rotatably installed in or fixed to the valve guide. Although not shown in the figure, each of the fuel mixing means 400 and 500 may further comprise the reinforcing rim and the auxiliary blades fixed to the reinforcing rim. Further, if the inclination angle of the blades of the first fuel mixing means 400 with respect to the valve guide is different from that of the blades of the second fuel mixing means 500, the rotational speed of the first fuel mixing means 400 becomes different from that of the second fuel mixing means 500, so that a stronger swirl can be produced in the mixture passing the respective fuel mixing means. Particularly, if the inclined direction of the blades of the first fuel mixing means 400 with respect to the valve guide is opposite to that of the blades of the second fuel mixing means 500, the rotating directions of the two fuel mixing means are opposite to each other, so that a stronger swirl can be produced in the mixture.

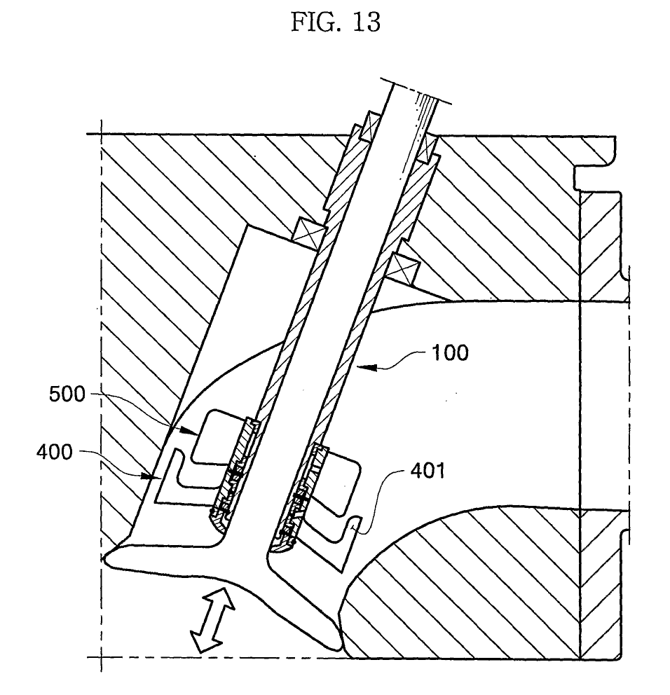

FIG. 13 is a sectional view showing a state where an eighth embodiment of the swirling valve guide according to the present invention is installed in a cylinder head.

Likewise the previous seventh embodiment, this embodiment has a plurality of fuel mixing means 400 and 500. However, the shapes of the blades of the first fuel mixing means 400 are different from those of the previous embodiments. That is, each of the blades of the first fuel mixing means 400 is formed with an extension 401 that extends from an end of the blade toward the upstream side of the intake port. The extension 401 may be positioned outside the blades of the second fuel mixing means 500 adjacent thereto. In this case, since the extensions 401 of the blades of the first fuel mixing means 400 and the blades of the second fuel mixing means 500 are positioned together in a plane perpendicular to the longitudinal direction of the valve guide, it is possible to produce a stronger swirl in the mixture. Although not shown in the figure, each of the fuel mixing means of this embodiment may also further comprise the reinforcing rim and the auxiliary blades fixed to the reinforcing rim.

### INDUSTRIAL APPLICABILITY

As described above, according to the present invention, a fuel mixing means is installed on a valve guide adjacent to a combustion chamber to produce a swirl so that a mixture of fuel and air can be introduced into the combustion chamber in a state where the fuel and air are appropriately mixed with each other. In addition, the fuel mixing means is installed on a conventional valve guide to minimize a disturbance of the flow of the mixture. Further, since a swirl can be produced in the mixture a position close to the combustion chamber regardless of impact caused by reciprocation of a valve, it is possible to effectively mix the fuel and air with each other.

It is intended that the embodiments of the present invention described above and illustrated in the drawings should not be construed as limiting the technical spirit of the present invention. The scope of the present invention is defined only by the appended claims. It is apparent that those skilled in the art can make various changes and modifications thereto. Therefore, such changes and modifications fall within the scope of the present invention so far as they are obvious to those skilled in the art.

1. A swirling valve guide including a guide portion installed to protrude into an intake port of a cylinder head of an internal combustion engine for guiding reciprocation of an intake valve of the internal combustion engine, comprising:
a fuel mixing mean having a member installed on an outer peripheral surface of the guide portion to mix fuel and air passing the intake port and to produce a swirl in a mixture of the fuel and air at a downstream side of the flow of the mixture.

2. The swirling valve guide according to claim 1, wherein the member for forming the swirl comprises at least one blade fixed on the outer peripheral surface of the guide portion.

3. The swirling valve guide according to claim 2, wherein the fuel mixing means further comprises a hub rotatably installed on the outer peripheral surface of the guide portion, said at least one blade being fixed to an outer peripheral surface of the hub.

4. The swirling valve guide according to claim 2, wherein a plurality of blades are provided and the valve guide further comprises a reinforcing rim with an inner peripheral surface connected to ends of the plurality of blades.

5. The swirling valve guide according to claim 3, wherein a plurality of blades are provided and the valve guide further comprises a reinforcing rim with an inner peripheral surface connected to ends of the plurality of blades.

6. The swirling valve guide according to claim 5, further comprising: an auxiliary blade fixed to at least one of outer and inner peripheral surfaces of the reinforcing rim.

7. The swirling valve guide according to claim 3, wherein a plurality of blades are provided, and the blades are arranged equidistantly in a circumferential direction on the outer peripheral surface of the guide portion.

8. The swirling valve guide according to claim 2, wherein said at least one blade has a spiral shape that is inclined at a predetermined angle with respect to a longitudinal direction of the valve guide.

9. The swirling valve guide according to claim 2, wherein said at least one blade is formed with an extension at an end thereof, said extension extending toward an upstream side of the intake port.

10. The swirling valve guide according to claim 2, wherein a plurality of fuel mixing means are provided, and the blade of one of the fuel mixing means has a spiral shape inclined at a predetermined angle with respect to a longitudinal direction of the valve guide and has an inclination angle different from that of the blade of the adjacent fuel mixing means.
